(19) United States
(12) Patent Application Publication
(10) Pub. No.: US 2023/0139193 A1
(43) Pub. Date: May 4, 2023

(54) INDOOR DIRECTION FINDING METHOD AND SYSTEM THEREOF

(71) Applicant: AIXlink Ltd., Chengdu City (CN)

(72) Inventor: Chih-Cheng LIN, Hsinchu City (TW)

(73) Assignee: AIXlink Ltd., Chengdu City (CN)

(21) Appl. No.: 17/975,611

(22) Filed: Oct. 28, 2022

Related U.S. Application Data
(60) Provisional application No. 63/274,484, filed on Nov. 1, 2021.

(51) Int. Cl. G01S 5/06

(52) U.S. Cl. CPC G01S 5/06; G01S 2201/02

(57) ABSTRACT

The present disclosure provides an indoor direction finding method, which is applied to an indoor direction finding system. The indoor direction finding system comprises a transmitter and a receiver. A Bluetooth communication link is established between the receiver and the transmitter. The indoor direction finding method is performed by the receiver with the steps of: obtaining a receiver coordinate information of the receiver; receiving a Bluetooth signal moving in single direction at the receiver coordinate information; confirming a relative position information of the transmitter according to the receiver coordinate information and the Bluetooth signal moving in single direction. By obtaining the Bluetooth signal moving in single direction, the azimuth of the transmitter can be confirmed for improving the indoor direction finding accuracy.

### CROSS-REFERENCE TO RELATED APPLICATION

This application claims the priority benefit of U.S. Patent Application Ser. No. 63/274,484, filed on Nov. 1, 2021, the full disclosure of which is incorporated herein by reference.

### BACKGROUND

### Technical Field

The present disclosure relates to the technical field of direction finding, particularly to indoor direction finding method and indoor direction finding system.

### Related Art

In the conventional indoor direction finding method, a Bluetooth connection is often established between a Bluetooth tag and a wireless base station. The Bluetooth tag would first transmit a Bluetooth signal to the wireless base station and the wireless base station obtains a relative position between the Bluetooth tag and the wireless base station according to the angle between the wireless base station and the received Bluetooth signal and the distance between the antenna modules received by the wireless base station. Based on the fact that the position of the wireless base station is known, the position of the Bluetooth tag can be obtained for achieving indoor direction finding according to the obtained relative position and the position of the wireless base station.

In another indoor direction finding method, it mainly broadcasts the Bluetooth signal to the wireless base station through the Bluetooth tag. The wireless base station obtains the distance between the wireless base station and the Bluetooth tag according to a received signal strength indication (RSSI) of the received Bluetooth signal to obtain the relative position. Since the position of the wireless base station is known, the position of the Bluetooth tag could be obtained according to the obtained relative position and the position of the wireless base station.

However, in the conventional indoor direction finding method which is mainly angle based or RSSI based, the angle-based indoor direction finding method could achieve indoor direction finding under the conditions of different angles (e.g. 30° or 45°), and the RSSI-based indoor direction finding method achieves indoor direction finding under the conditions of different received signal strength indications (e.g. −10 dBm or −20 dBm). When the angles or distances are identical (e.g. 30° and 120°, and the RSSI is −10 dB at 30° and −10 dB at 120°), the angle based or RSSI based indoor direction finding method would obtain identical relative position. So, there would be wrongly performed indoor direction finding which affects the accuracy of the indoor direction finding method.

Thus, an improved solution for the prior arts is essential.

### SUMMARY

The embodiments of the present disclosure provide an indoor direction finding method and an indoor direction finding system to confirm the azimuth of the transmitter by obtaining a Bluetooth signal that moves in single direction to improve the indoor direction finding accuracy.

For achieving the above purpose, the aforementioned indoor direction finding method is applied to an indoor direction finding system. The indoor direction finding system comprises a transmitter and a receiver. A Bluetooth communication link is established between the receiver and the transmitter. Wherein the indoor direction finding method is performed by the receiver with the following steps: obtaining a receiver coordinate information of the receiver;

receiving a Bluetooth signal moving in single direction at the receiver coordinate information; and
confirming a relative position information of the transmitter according to the receiver coordinate information and the Bluetooth signal moving in single direction.

Preferably, the step of “confirming a relative position information of the transmitter according to the receiver coordinate information and the Bluetooth signal moving in single direction” comprises the following sub-steps:

obtaining an angular phase difference information, a distance, and a relative azimuth according to the receiver coordinate information and the Bluetooth signal moving in single direction; and
confirming the relative position information of the transmitter according to the angular phase difference information, the distance, and the relative azimuth.

Preferably, the step of “obtaining an angular phase difference information, a distance, and a relative azimuth according to the receiver coordinate information and the Bluetooth signal moving in single direction” comprises the following sub-steps:

predetermining an antenna distance; and
obtaining the angular phase difference information according to the receiver coordinate information, the Bluetooth signal moving in single direction, and the antenna distance.

Preferably, the step of “obtaining an angular phase difference information, a distance, and a relative azimuth according to the receiver coordinate information and the Bluetooth signal moving in single direction” comprises the following sub-steps: receiving the Bluetooth signal moving in single direction;

obtaining a corresponding received signal strength indication (RSSI) according to a transmission power of the Bluetooth signal moving in single direction; and obtaining the distance according to the receiver coordinate information and the received signal strength indication.

Preferably, the step of “obtaining an angular phase difference information, a distance, and a relative azimuth according to the receiver coordinate information and the Bluetooth signal moving in single direction” comprises the following sub-steps: obtaining a transmitter frequency signal;

obtaining a frequency signal according to the transmitter frequency signal, a speed of sound, a transmitter moving speed of the Bluetooth signal moving in single direction, and a receiver moving speed of the receiver; and
comparing the frequency signal according to the transmitter frequency signal to determine whether the frequency signal is greater than the transmitter frequency signal for the obtaining of the relative azimuth;
if so, it can be determined that the transmitter is approaching the receiver;
if not, it can be determined that the transmitter is moving away from the receiver.

With the above-mentioned methods, the receiver receives the Bluetooth signal moving in single direction transmitted by the transmitter at the receiver coordinate information to confirm a relative position information of the transmitter according to the receiver coordinate information and the Bluetooth signal moving in single direction. So, the transmitter azimuth can be confirmed to improve the indoor direction finding accuracy.

For achieving the above purpose, an indoor direction finding system is provided, which comprises:

a transmitter transmitting a Bluetooth signal moving in single direction; and
a receiver establishing a Bluetooth communication link with the transmitter;
wherein, the receiver: obtains a receiver coordinate information of the receiver; receives the Bluetooth signal moving in single direction at the receiver coordinate information; obtains an angular phase difference information, a distance, and a relative azimuth according to the receiver coordinate information and the Bluetooth signal moving in single direction; confirms a relative position information of the transmitter according to the angular phase difference information, the distance, and the relative azimuth.

Preferably, the receiver comprises: an antenna array module receiving the Bluetooth signal moving in single direction; a memory module predetermining an antenna distance; and a processing module connected to the antenna array module and the memory module; wherein, the processing module obtains the angular phase difference information according to the receiver coordinate information, the Bluetooth signal moving in single direction, and the antenna distance.

Preferably, the processing module obtains a corresponding received signal strength indication according to a transmission power of the Bluetooth signal moving in single direction, and obtains the distance according to the receiver coordinate information and the received signal strength indication.

Preferably, the receiver further comprises: a signal processing module connected to the antenna array module and the processing module; the signal processing module performs a frequency offset demodulation for a frequency offset modulation signal to generate a digital value after obtaining the Bluetooth signal moving in single direction is processed by a Gaussian low-pass filter and modulated by a frequency offset to generate the frequency offset modulation signal.

Preferably, the processing module generates a transmitter frequency signal according to the digital value. The processing module obtains a frequency signal according to the transmitter frequency signal, a speed of sound, a transmitter moving speed of the Bluetooth signal moving in single direction, and a receiver moving speed of the receiver, and compares the frequency signal according to the transmitter frequency signal to determine whether the frequency signal is greater than the transmitter frequency signal to obtain the relative azimuth.

With the above-mentioned configuration, the receiver could receive the Bluetooth signal moving in single direction transmitted by the transmitter at the receiver coordinate information to confirm a relative position information of the transmitter according to the receiver coordinate information and the Bluetooth signal moving in single direction. In this way, the azimuth of the transmitter can be confirmed, thereby improving the indoor direction finding accuracy.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of an indoor direction finding system of the present disclosure;

FIG. 2 is another block diagram of an indoor direction finding system of the present disclosure;

FIG. 3A is an application schematic diagram of the indoor direction finding system of the present disclosure;

FIG. 3B is another application schematic diagram of the indoor direction finding system of the present disclosure;

FIG. 4 is a flow chart of an indoor direction finding method of the present disclosure;

FIG. 5 is another flow chart of an indoor direction finding method of the present disclosure;

FIG. 6A is yet another flow chart of an indoor direction finding method of the present disclosure;

FIG. 6B is yet another flow chart of an indoor direction finding method of the present disclosure; and

FIG. 6C is yet another flow chart of an indoor direction finding method of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

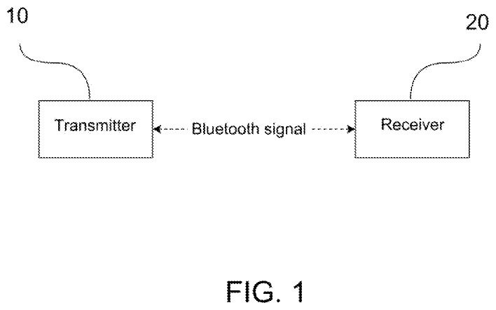

Regarding preferred embodiments of an indoor direction finding system of the present disclosure, as shown in FIG. 1, the indoor direction finding system comprises a transmitter 10 and a receiver 20. A Bluetooth communication link is established between the transmitter 10 and the receiver 20 with a Bluetooth signal. The transmitter 10 transmits a Bluetooth signal moving in single direction. The receiver 20 obtains a receiver coordinate information and receives a Bluetooth signal moving in single direction at the receiver coordinate information. The receiver 20 obtains an angular phase difference information, a distance, and a relative azimuth according to the receiver coordinate information and the Bluetooth signal moving in single direction, and confirms a relative position information of the transmitter 10 according to the angular phase difference information, the distance, and the relative azimuth. In this embodiment, the transmitter 10 could be a Bluetooth tag or a wireless base station, The receiver 20 could be a wireless base station or a Bluetooth tag.

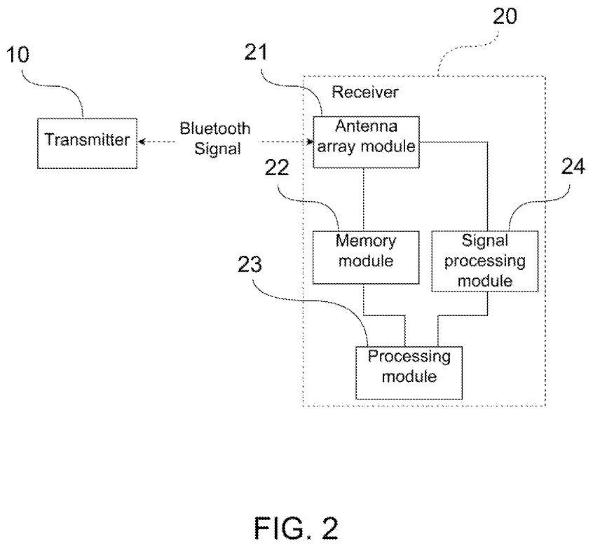

In this embodiment, as shown in FIG. 2, the receiver 20 comprises an antenna array module 21, a memory module 22, and a processing module 23. The processing module 23 is electrically connected to the antenna array module 21 and the memory module 22. The antenna array module 21 receives the Bluetooth signal moving in single direction from the transmitter 10. The memory module 22 predetermines an antenna distance. The processing module 23 obtains the angular phase difference information according to the receiver coordinate information, the Bluetooth signal moving in single direction, and the antenna distance. The receiver 20 obtains the relative position information according to the receiver coordinate information and the angular phase difference information. In this embodiment, the relative position information can be acquired through a signal angle of arrival (AOA) or a signal angle of departure (AOD). The memory module 22 could be a memory, and the processing module 23 could be a processor.

In this embodiment, the processing module 23 converts the transmission power into a received signal strength indication (RSSI) according to a transmission power of the Bluetooth signal moving in single direction, and compares with the receiver coordinate information and the received signal strength indication according to a pre-established model in a corresponding distance to the received signal strength indication to obtain a distance between the transmitter 10 and the receiver 20. The receiver 20 obtains the relative position information according to the receiver coordinate information and the distance.

In this embodiment, the receiver 20 further comprises a signal processing module 24, which is electrically connected to the antenna array module 21 and the processing module 23. The signal processing module 24 performs a frequency offset demodulation for a frequency offset modulation signal to generate a digital value after obtaining the Bluetooth signal moving in single direction is processed by a Gaussian low-pass filter and modulated by a frequency offset to generate the frequency offset modulation signal.

In this embodiment, the processing module 23 generates a transmitter frequency signal according to the digital value. Then, the processing module 23 obtains a frequency signal according to the transmitter frequency signal, a speed of sound, a transmitter moving speed of the Bluetooth signal moving in single direction, and a receiver moving speed of the receiver 20, and according to the transmitter frequency signal, the frequency signal is compared to determine whether the frequency signal is greater than the transmitter frequency signal to obtain the relative azimuth of the transmitter 10 and the receiver 20. If so, it can be determined that the transmitter 10 is approaching the receiver 20. If not, it can be determined that the transmitter 10 is moving away from the receiver 20 to obtain the relative azimuth.

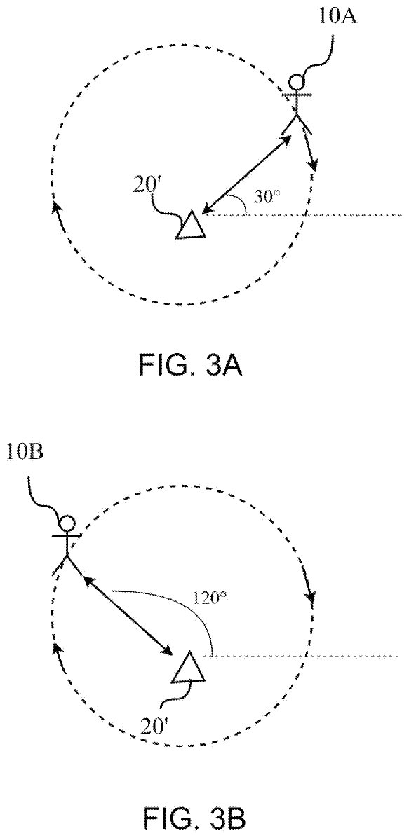

For example, as shown in FIG. 3A and FIG. 3B, the transmitter 10 is a Bluetooth tag, the receiver 20 is a wireless base station 20′. The user possesses a Bluetooth tag, which transmits a Bluetooth signal. The wireless base station 20′ predetermines a receiver coordinate information. The wireless base station 20′ is relatively set at a coordinate according to the receiver coordinate information, and receives the Bluetooth signal from the Bluetooth tag. Then, the user advances in the direction of the arrow, so that the Bluetooth tag continues to transmit the Bluetooth signal moving in single direction to the wireless base station 20′. The antenna array module 21 of the wireless base station 20′ comprises two antennas, between which is an antenna distance. The antenna distance is stored in the memory module 22 of the wireless base station 20′. The two antennas of the wireless base station 20′ respectively receive the Bluetooth signal moving in single direction from the Bluetooth tag. Then, when the two antennas of the antenna array module 21 respectively receive the Bluetooth signal moving in single direction, the angular phase difference information is obtained. The wireless base station 20′ then calculates and obtains the relative position information of the Bluetooth tag in the wireless base station 20′ according to the received signal strength indication and the angle phase difference information, i.e., the relative angle of the Bluetooth tag to the wireless base station 20′.

Moreover, according to the transmission power of the Bluetooth signal moving in single direction, the wireless base station 20′ converts the transmission power into the received signal strength indication, and compares with the receiver coordinate information and the received signal strength indication according to the pre-established model in a corresponding distance to the received signal strength indication to obtain the distance between the Bluetooth tag and the wireless base station 20′. Then, the wireless base station 20′ calculates the relative position information between the Bluetooth tag and the wireless base station 20′ according to the receiver coordinate information and the distance.

The wireless base station 20′ performs a frequency offset demodulation for a frequency offset modulation signal to generate a digital value after obtaining the Bluetooth signal moving in single direction is processed by a Gaussian low-pass filter and modulated by a frequency offset to generate the frequency offset modulation signal. The wireless base station 20′ then generates the transmitter frequency signal according to the digital value. The frequency signal is calculated according to the transmitter frequency signal, the speed of sound, the transmitter moving speed of the Bluetooth tag of the Bluetooth signal moving in single direction, and the receiver moving speed of the wireless base station 20′. The equation is as shown below.

$${f}^{′} = ( \frac{v \pm {v}_{o}}{v ▯ {v}_{s}} ) f$$

In the equation: f′ represents frequency signal; f represents the transmitter frequency signal; v represents the speed of sound; vₒ represents the receiver moving speed; vₛ represents the transmitter moving speed.

To make a comparison between the frequency signal and the transmitter frequency signal, when the frequency signal is greater than the transmitter frequency signal, it is determined that the Bluetooth tag is moving in a direction close to the wireless base station 20′. When the frequency signal is smaller than the transmitter frequency signal, it is determined that the Bluetooth tag is moving in a direction away from the wireless base station 20′. In this way, the relative azimuth between the Bluetooth tag and the wireless base station 20′ can be acquired accurately.

For example, as shown in FIG. 3A and FIG. 3B, the Bluetooth tags possessed by the user is at the positions 10A and 10B of the Bluetooth tag. The relative horizontal angles of the Bluetooth tags at the positions 10A and 10B of the Bluetooth tag to the wireless base station 20′ are 30° and 120°, respectively, and the Bluetooth tags at the positions 10A and 10B of the Bluetooth tag move on a circumference of one circle, which implies that the received signal strength indication of the positions 10A and 10B where the wireless base station 20′ receives the Bluetooth tags are identical so that the distances are also identical. In the aspect of a plane, on which the positions 10A and 10B of the Bluetooth tags are positions that are actually different, so when the Bluetooth tags are at the positions 10A and 10B of the Bluetooth tag, the frequencies of the Bluetooth signals moving in single direction correspondingly received by the wireless base station 20′ are different, so it can be determined that the user is at the position 10A or the position 10B of the Bluetooth tag. When at the position 10A of the Bluetooth tag, the Bluetooth tag at the position 10A of the Bluetooth tag is moving at a speed close to the wireless base station 20′ so that the frequency signal is greater than the transmitter frequency signal, and it can be determined that the Bluetooth tag is approaching the position of the wireless base station 20′ when the Bluetooth tag is at the position 10A. On the contrary, it can be determined that the Bluetooth tag is moving away from the wireless base station 20′ at the position 10B of the Bluetooth tag. In this way, the positions 10A and 10B of the Bluetooth tags can be accurately determined.

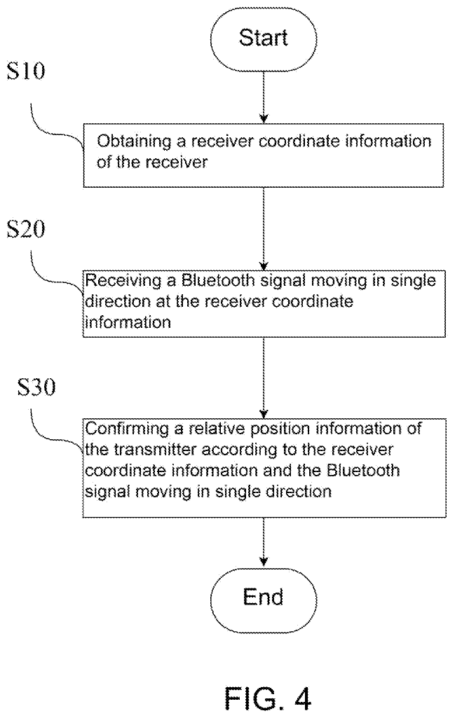

Besides, regarding a preferred embodiment of the indoor direction finding method of the present disclosure, as shown in FIG. 4, the indoor direction finding method is applied to an indoor direction finding system, which comprises a transmitter and a receiver. A Bluetooth communication link is established between the receiver and the transmitter. Wherein the indoor direction finding method is performed by the receiver with the following steps:

obtaining a receiver coordinate information of the receiver (S10);
receiving a Bluetooth signal moving in single direction at the receiver coordinate information (S20); and confirming a relative position information of the transmitter according to the receiver coordinate information and the Bluetooth signal moving in single direction (S30).

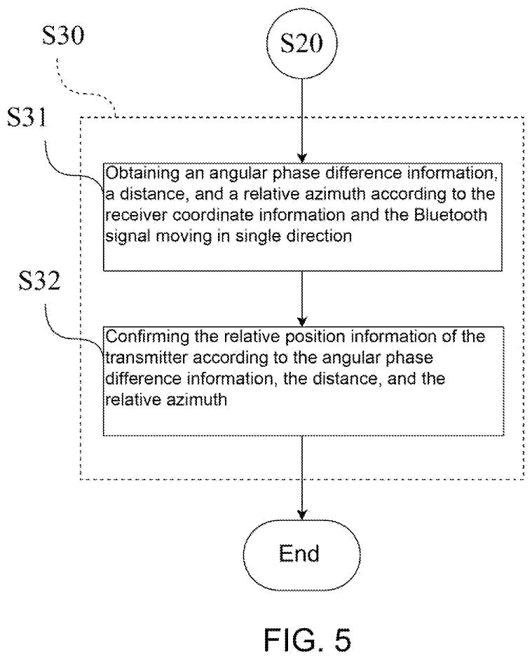

In this embodiment, as shown in FIG. 5, the step of “confirming a relative position information of the transmitter according to the receiver coordinate information and the Bluetooth signal moving in single direction (S30)” comprises the following sub-steps:

obtaining an angular phase difference information, a distance, and a relative azimuth according to the receiver coordinate information and the Bluetooth signal moving in single direction (S31); and
confirming the relative position information of the transmitter according to the angular phase difference information, the distance, and the relative azimuth (S32).

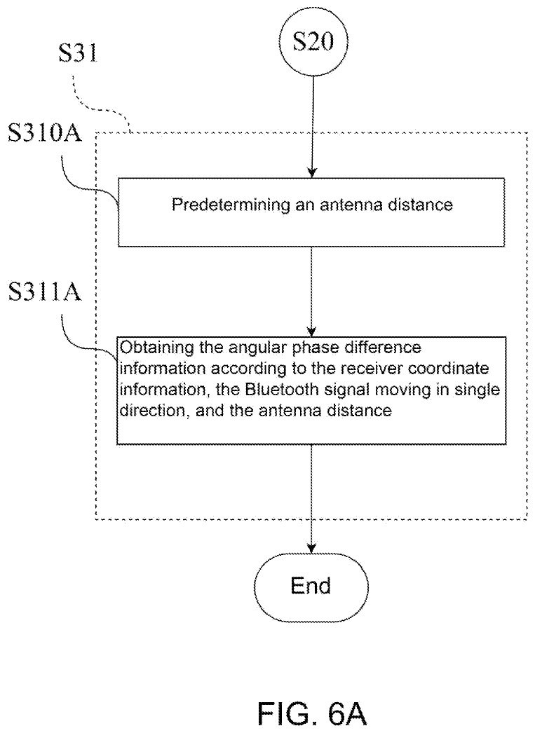

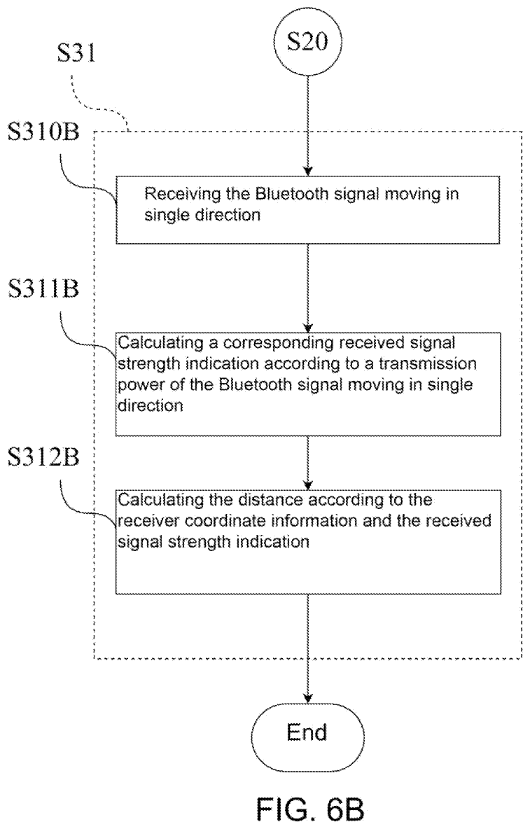

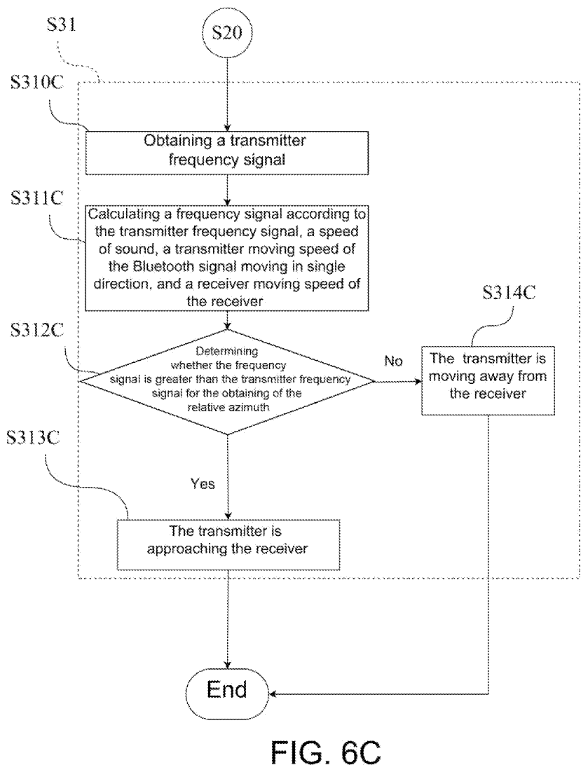

In this embodiment, as shown in FIG. 6A, the step of “obtaining an angular phase difference information, a distance, and a relative azimuth according to the receiver coordinate information and the Bluetooth signal moving in single direction (S31)” comprises the following sub-steps:

predetermining an antenna distance (S310A); and
obtaining the angular phase difference information according to the receiver coordinate information, the Bluetooth signal moving in single direction, and the antenna distance (S311A).

In this embodiment, as shown in FIG. 6B, the step of “obtaining an angular phase difference information, a distance, and a relative azimuth according to the receiver coordinate information and the Bluetooth signal moving in single direction (S31)” comprises the following sub-steps:

receiving the Bluetooth signal moving in single direction (S310B);
calculating a corresponding received signal strength indication according to a transmission power of the Bluetooth signal moving in single direction (S311B); and
calculating the distance according to the receiver coordinate information and the received signal strength indication (S312B).

In this embodiment, as shown in FIG. 6C, the step of “obtaining an angular phase difference information, a distance, and a relative azimuth according to the receiver coordinate information and the Bluetooth signal moving in single direction (S31)” comprises the following sub-steps:

obtaining a transmitter frequency signal (S310C);
calculating a frequency signal according to the transmitter frequency signal, a speed of sound, a transmitter moving speed of the Bluetooth signal moving in single direction, and a receiver moving speed of the receiver (S311C); and
comparing the frequency signal according to the transmitter frequency signal to determine whether the frequency signal is greater than the transmitter frequency signal for the obtaining of the relative azimuth (S312C);
if so, it can be determined that the transmitter is approaching the receiver (S313C);
if not, it can be determined that the transmitter is moving away from the receiver (S314C).

In summary, the receiver could receive the Bluetooth signal moving in single direction transmitted by the transmitter at the receiver coordinate information to confirm a relative position information of the transmitter according to the receiver coordinate information and the Bluetooth signal moving in single direction. In this way, the azimuth of the transmitter can be confirmed, thereby improving the indoor direction finding accuracy.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An indoor direction finding method, applied to an indoor direction finding system, the indoor direction finding system comprising a transmitter and a receiver, a Bluetooth communication link being established between the receiver and the transmitter; wherein the indoor direction finding method is performed by the receiver with the following steps:
obtaining a receiver coordinate information of the receiver;
receiving a Bluetooth signal moving in single direction at the receiver coordinate information; and
confirming a relative position information of the transmitter according to the receiver coordinate information and the Bluetooth signal moving in single direction.

2. The indoor direction finding method according to claim 1, wherein the step of “confirming a relative position information of the transmitter according to the receiver coordinate information and the Bluetooth signal moving in single direction” comprises the following sub-steps:
obtaining an angular phase difference information, a distance, and a relative azimuth according to the receiver coordinate information and the Bluetooth signal moving in single direction; and
confirming the relative position information of the transmitter according to the angular phase difference information, the distance, and the relative azimuth.

3. The indoor direction finding method according to claim 2, wherein the step of “obtaining an angular phase difference information, a distance, and a relative azimuth according to the receiver coordinate information and the Bluetooth signal moving in single direction” comprises the following sub-steps:
predetermining an antenna distance; and
obtaining the angular phase difference information according to the receiver coordinate information, the Bluetooth signal moving in single direction, and the antenna distance.

4. The indoor direction finding method according to claim 2, wherein the step of “obtaining an angular phase difference information, a distance, and a relative azimuth according to the receiver coordinate information and the Bluetooth signal moving in single direction” comprises the following sub-steps:
receiving the Bluetooth signal moving in single direction;
calculating a corresponding received signal strength indication according to a transmission power of the Bluetooth signal moving in single direction; and
obtaining the distance according to the receiver coordinate information and the received signal strength indication.

5. The indoor direction finding method according to claim 2, wherein the step of “obtaining an angular phase difference information, a distance, and a relative azimuth according to the receiver coordinate information and the Bluetooth signal moving in single direction” comprises the following sub-steps:
obtaining a transmitter frequency signal;
calculating a frequency signal according to the transmitter frequency signal, a speed of sound, a transmitter moving speed of the Bluetooth signal moving in single direction, and a receiver moving speed of the receiver; and
comparing the frequency signal according to the transmitter frequency signal to determine whether the frequency signal is greater than the transmitter frequency signal for the obtaining of the relative azimuth;
if so, it can be determined that the transmitter is approaching the receiver;
if not, it can be determined that the transmitter is moving away from the receiver.

6. An indoor direction finding system, comprising:
a transmitter transmitting a Bluetooth signal moving in single direction; and
a receiver establishing a Bluetooth communication link with the transmitter;
wherein, the receiver: obtains a receiver coordinate information of the receiver; receives the Bluetooth signal moving in single direction at the receiver coordinate information; obtains an angular phase difference information, a distance, and a relative azimuth according to the receiver coordinate information and the Bluetooth signal moving in single direction; confirms a relative position information of the transmitter according to the angular phase difference information, the distance, and the relative azimuth.

7. The indoor direction finding system according to claim 6, wherein the receiver comprises:
an antenna array module receiving the Bluetooth signal moving in single direction;
a memory module predetermining an antenna distance; and
a processing module connected to the antenna array module and the memory module;
wherein, the processing module obtains the angular phase difference information according to the receiver coordinate information, the Bluetooth signal moving in single direction, and the antenna distance.

8. The indoor direction finding system according to claim 7, wherein the processing module calculates a corresponding received signal strength indication according to a transmission power of the Bluetooth signal moving in single direction, and obtains the distance according to the receiver coordinate information and the received signal strength indication.

9. The indoor direction finding system according to claim 8, wherein the receiver comprises:
a signal processing module connected to the antenna array module and the processing module; the signal processing module performs a frequency offset demodulation for a frequency offset modulation signal to generate a digital value after obtaining the Bluetooth signal moving in single direction is processed by a Gaussian low-pass filter and modulated by a frequency offset to generate the frequency offset modulation signal.

10. The indoor direction finding system according to claim 9, wherein the processing module generates a transmitter frequency signal according to the digital value; the processing module calculates a frequency signal according to the transmitter frequency signal, a speed of sound, a transmitter moving speed of the Bluetooth signal moving in single direction, and a receiver moving speed of the receiver, and determines whether the frequency signal is greater than the transmitter frequency signal to obtain the relative azimuth according to the transmitter frequency signal and the frequency signal.
